(19) United States
(12) Patent Application Publication
(10) Pub. No.: US 2007/0282089 A1
(43) Pub. Date: Dec. 6, 2007

(54) Method for producing solid highly-reactive polyurethane compositions containing uretdione groups

(75) Inventor: Emmanouil Spyrou, Schermbeck (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/591,814

(22) PCT Filed: Jan. 13, 2005
(86) PCT No.: PCT/EP05/50120

§ 371 Date: May 24, 2007

(30) Foreign Application Priority Data
Mar. 6, 2004 (DE) 10 2004 011 004.2

(51) Int. Cl. C08G 18/00

(52) U.S. Cl. 528/44

(57) ABSTRACT

The invention relates to a process for preparing solid highly reactive polyurethane compositions which contain uretdione groups and cure at low baking temperatures, to compositions of this kind, and to their use for producing polymers, especially powder coatings, which crosslink to high-gloss or matt, light-stable and weather-stable coating films.

The invention relates to a process for preparing solid highly reactive polyurethane compositions which contain uretdione groups and cure at low baking temperatures, to compositions of this kind, and to their use for producing polymers, especially powder coatings, which crosslink to high-gloss or matt, light-stable and weather-stable coating films.

Externally or internally blocked polyisocyanates which are solid at room temperature are valuable crosslinkers for thermally crosslinkable polyurethane (PU) powder coating compositions.

For instance DE-A 27 35 497 describes PU powder coatings having outstanding weathering stability and thermal stability. The crosslinkers whose preparation is described in DE-A 27 12 931 are composed of ε-caprolactam-blocked isophorone diisocyanate containing isocyanurate groups. Also known are polyisocyanates containing urethane, biuret or urea groups, and whose isocyanate groups are likewise blocked.

The drawback of these externally blocked systems lies in the elimination of the blocking agent during the thermal crosslinking reaction. Since the blocking agent may thus be emitted to the environment it is necessary on environmental and workplace safety grounds to take particular measures to clean the outgoing air and/or to recover the blocking agent. The crosslinkers, moreover, are of low reactivity. Curing temperatures above 170° C. are required.

DE-A 30 30 539 and DE-A 30 30 572 describe processes for preparing polyaddition compounds which contain uretdione groups and whose terminal isocyanate groups are irreversibly blocked with monoalcohols or monoamines. Particular drawbacks are the chain-terminating constituents of the crosslinkers, which lead to low network densities in the PU powder coatings and hence to moderate solvent resistances.

Hydroxyl-terminated polyaddition compounds containing uretdione groups are subject matter of EP 0 669 353. Because of their functionality of two they exhibit improved resistance to solvents. Powder coating compositions based on these polyisocyanates containing uretdione groups share the feature that, during the curing reaction, they do not emit any volatile compounds. At not less than 180° C., however, the baking temperatures are at a high level.

The use of amidines as catalysts in PU powder coating compositions is described in EP 0 803 524. Although these catalysts do lead to a reduction in the curing temperature they exhibit considerable yellowing, which is generally unwanted in the coatings sector. The cause of this yellowing is presumed to be reactive nitrogen atoms in the amidines. They are able to react with atmospheric oxygen to form N-oxides, which are responsible for the discoloration.

EP 0 803 524 also mentions other catalysts which have been used to date for this purpose, but without indicating any particular effect on the curing temperature. Such catalysts include the organometallic catalysts known from polyurethane chemistry, such as dibutyltin dilaurate (DBTL), or else tertiary amines, such as 1,4-diazabicyclo[2.2.2]octane (DABCO), for example.

WO 00/34355 claims catalysts based on metal acetylacetonates: zinc acetylacetonate, for example. Such catalysts are actually capable of lowering the curing temperature of polyurethane powder coating compositions containing uretdione groups (M. Gedan-Smolka, F. Lehmann, D. Lehmann “New catalysts for the low temperature curing of uretdione powder coatings” International Waterborne, High solids and Powder Coatings Symposium, New Orleans, Feb. 21-23, 2001).

Powder coating compositions following their preparation are generally ground and sieved. The resulting powder particles (usually 5-200 μm) must not undergo caking, including in the course of storage, since otherwise spray application would be disrupted. In order to ensure this physical storage stability, therefore, the powder coating compositions need to have a glass transition point of 40-50° C. at the minimum. Powder coating compositions having such a glass transition point, however, generally melt only at temperatures between 90 and 130° C.

As a consequence all catalysts which lead to highly reactive powder coating compositions are difficult to incorporate into the powder coating compositions. The reason for this is that the processing temperature (extrusion temperature) and the melting temperature of the powder coating compositions are very close to the reaction temperature (130-150° C.). During extrusion there may be unwanted instances of premature crosslinking or else the powder coating composition cures on the substrate before it has been able to form a uniform surface. In both cases the results are unwanted surface defects.

It was an object of the present invention, therefore, to find a process for preparing solid highly reactive polyurethane compositions which contain uretdione groups and can be cured even at very low temperatures, which are suitable in particular for producing polymers and also high-gloss or matt, light-stable and weather-stable powder coatings but do not exhibit any pronounced surface defects.

Surprisingly it has been found that the incorporation of highly active catalysts into polyurethane compositions containing uretdione groups at a later point in time than at the beginning of the mixing operation at temperatures from 70 to 170° C. leads to highly reactive compositions, especially powder coating compositions, which after curing on the substrate exhibit only slight, if any, surface defects.

The present invention provides a process for preparing a solid highly reactive polyurethane composition containing uretdione groups by mixing
A) at least one uretdione-containing curing agent which has a free NCO content of less than 5% by weight and a uretdione content of 1-30% by weight, based on aromatic, aliphatic, (cyclo)aliphatic or cycloaliphatic polyisocyanates and hydroxyl-containing compounds, with a melting point of from 40 to 130° C.,
   and
B) if desired at least one hydroxyl-containing polymer having a melting point of from 40 to 130° C. and an OH number of between 20 and 200 mg KOH/gram,
C) in the presence of at least one catalyst
   C1) of the formula M(OR¹)ₙ(OR²)ₘ(OR³)ₒ(OR⁴)ₚ(OR⁵)_{q}(OR⁶)ᵣ, where M is a metal in any positive oxidation state and identical to the sum n+m+o+p+q+r, m, o, p, q and r are integers from 0 to 6 and the sum n+m+o+p+q+r=1-6, the radicals R¹-R⁶ simultaneously or independently of one another are hydrogen or alkyl, aryl, aralkyl, heteroaryl or alkoxyalkyl radicals having 1-8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, urethane, urea or allophanate groups, double bonds, triple bonds or halogen atoms,
   and/or
   C2) comprising tetraalkylammonium salts of the formula [NR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F,
   and/or
   C3) of the formula [NR¹R²R³R⁴]⁺[R⁵COO]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical, linear or branched, having 1-18 carbon atoms and may further contain one or more alcohol, amino, ester, keto, thio, acid, urethane, urea or allophanate groups, double bonds, triple bonds or halogen atoms,
   and/or
   C4) comprising metal acetylacetonates of the formula Mⁿ⁺(acac⁻)ₙ, where M=metal ion, n is a natural number, with n=1-6, and acac is bis(2,4-pentanedionato),
   C5) comprising phosphonium compounds of the formula [PR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F or is R⁶COO where R⁶ is synonymous with alkyl, aryl, aralkyl, heteroaryl or alkoxyalkyl radicals, linear or branched, having 1-18 carbon atoms and may further contain one or more alcohol, amino, ester, keto, thio, acid, urethane, urea or allophanate groups, double bonds, triple bonds or halogen atoms,
      so that the fraction of the catalyst under C) is 0.001-5% by weight of the total amount of components A) and, if present, B),
D) if desired, a reactive compound which is able to react at elevated temperatures with the acid groups of component B) that may be present and whose fraction is from 0.1 to 10% by weight based on the total amount of A) and, if present, B),
E) if desired, at least one acid in monomeric or polymeric form, in a weight fraction, based on the total formulation, of from 0.1 to 10%,
F) if desired, auxiliaries and additives
   in a mixing apparatus selected from an extruder, intensive kneader, intensive mixer or static mixer, component C) being added subsequently in the mixing apparatus to components A) and, if present, B), D), E) and/or F) already partly or fully mixed in the mixing apparatus and being mixed with the other components and subsequently isolating the end product by cooling.

Essential to the invention is the incorporation of a highly active catalyst C) into a polyurethane composition containing uretdione groups in a mixing apparatus, the addition taking place
a) in a specific region, preferably after 10, 20, 30 to 90%, 40-80%, 55-75%, of the overall length of the mixing apparatus, preferably close to the exit die, more preferably approximately in the last third of the mixing apparatus,
b) in a specific temperature range, of from 70 to 170° C., of the melted polyurethane composition, preferably at temperatures from 70 to 130° C.

The invention also provides solid highly reactive polyurethane compositions containing uretdione groups and obtained by mixing
A) at least one uretdione-containing curing agent which has a free NCO content of less than 5% by weight and a uretdione content of 1-30% by weight, based on aromatic, aliphatic, (cyclo)aliphatic or cycloaliphatic polyisocyanates and hydroxyl-containing compounds, with a melting point of from 40 to 130° C.,
   and
B) if desired at least one hydroxyl-containing polymer having a melting point of from 40 to 130° C. and an OH number of between 20 and 200 mg KOH/gram,
C) in the presence of at least one catalyst
   C1) of the formula M(OR¹)ₙ(OR²)ₘ(OR³)ₒ(OR⁴)ₚ(OR⁵)_{q}(OR⁶)ᵣ, where M is a metal in any positive oxidation state and identical to the sum n+m+o+p+q+r, m, o, p, q and r are integers from 0 to 6 and the sum n+m+o+p+q+r=1-6, the radicals R¹-R⁶ simultaneously or independently of one another are hydrogen or alkyl, aryl, aralkyl, heteroaryl or alkoxyalkyl radicals having 1-8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, urethane, urea or allophanate groups, double bonds, triple bonds or halogen atoms,
   and/or
   C2) comprising tetraalkylammonium salts of the formula [NR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F,
   and/or
   C3) of the formula [NR¹R²R³R⁴]⁺[R⁵COO]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical, linear or branched, having 1-18 carbon atoms and may further contain one or more alcohol, amino, ester, keto, thio, acid, urethane, urea or allophanate groups, double bonds, triple bonds or halogen atoms,
   and/or
   C4) comprising metal acetylacetonates of the formula Mⁿ⁺(acac⁻)ₙ, where M=metal ion, n is a natural number, with n=1-6, and acac is bis(2,4-pentanedionato),
   C5) comprising phosphonium compounds of the formula [PR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F or is R⁶COO where R⁶ is synonymous with alkyl, aryl, aralkyl, heteroaryl or alkoxyalkyl radicals, linear or branched, having 1-18 carbon atoms and may further contain one or more alcohol, amino, ester, keto, thio, acid, urethane, urea or allophanate groups, double bonds, triple bonds or halogen atoms,
      so that the fraction of the catalyst under C) is 0.001-5% by weight of the total amount of components A) and, if present, B),
D) if desired, a reactive compound which is able to react at elevated temperatures with the acid groups of component B) that may be present and whose fraction is from 0.1 to 10% by weight based on the total amount of A) and, if present, B),
E) if desired, at least one acid in monomeric or polymeric form, in a weight fraction, based on the total formulation, of from 0.1 to 10%,
F) if desired, auxiliaries and additives
   in a mixing apparatus selected from an extruder, intensive kneader, intensive mixer or static mixer, component C) being added subsequently in the mixing apparatus to components A) and, if present, B), D), E) and/or F) already partly or fully mixed in the mixing apparatus and being mixed with the other components and subsequently isolating the end product by cooling, and also for their use in powder coating materials.

Polyisocyanates containing uretdione groups are well known and are described in, for example, U.S. Pat. No. 4,476,054, U.S. Pat. No. 4,912,210, U.S. Pat. No. 4,929,724 and EP 0 417 603. A comprehensive overview of industrially relevant processes for dimerizing isocyanates to uretdiones is offered by J. Prakt. Chem. 336 (1994) 185-200. Conversion of isocyanates to uretdiones takes place generally in the presence of soluble dimerization catalysts, such as dialkylaminopyridines, trialkylphosphines, phosphoramides or imidazoles. The reaction, conducted optionally in solvents but preferably in their absence, is terminated by addition of catalyst poisons when a desired conversion has been reached. Excess monomeric isocyanate is separated off afterward by short-path evaporation. If the catalyst is sufficiently volatile the reaction mixture can be freed from the catalyst at the same time as monomer is separated off. In that case there is no need to add catalyst poisons. A broad range of isocyanates is suitable in principle for the preparation of polyisocyanates containing uretdione groups. Preferred for use in accordance with the invention are isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI) and tetramethylxylylene diisocyanate (TMXDI). Very particular preference is given to IPDI and HDI.

The conversion of these polyisocyanates carrying uretdione groups to curing agents A) containing uretdione groups involves the reaction of the free NCO groups with hydroxyl-containing monomers or polymers, such as polyesters, polythioethers, polyethers, polycaprolactams, polyepoxides, polyesteramides, polyurethanes or low molecular mass di-, tri- and/or tetraalcohols as chain extenders and, if desired, monoamines and/or monoalcohols as chain terminators, and has already been frequently described (EP 0 669 353, EP 0 669 354, DE 30 30 572, EP 0 639 598 or EP 0 803 524). Preferred curing agents A) containing uretdione groups have a free NCO content of less than 5% by weight and a uretdione group content of from 6 to 30% by weight (calculated as C₂N₂O₂, molecular weight 84). Preference is given to polyesters and monomeric dialcohols. Besides the uretdione groups, the curing agents may also contain isocyanurate, biuret, allophanate, urethane and/or urea structures.

In the case of the hydroxyl-containing polymers B) it is preferred to use polyesters, polyethers, polyacrylates, polyurethanes and/or polycarbonates having an OH number of 20-200 (in mg KOH/gram). Particular preference is given to using polyesters having an OH number of 30-150, an average molecular weight of 500-6000 g/mol and a melting point of between 40 and 130° C. Such binders have been described for example in EP 669 354 and EP 254 152. It will be appreciated that mixtures of such polymers can also be used. The amount of component B may be between 0 and 80% by weight, based on the total formulation.

Examples of the catalysts C1) are lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide and barium phenoxide.

Examples of catalysts C2) are methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and benzyltrimethylammonium fluoride.

Examples of catalysts C3) are tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate.

Examples of catalysts C4) are zinc acetylacetonate and lithium acetylacetonate.

Examples of catalysts C5) are tetrabutylphosphonium acetate, tetrabutylphosphonium benzotriazolate, tetrabutylphosphonium hydroxide, ethyltriphenylphosphonium acetate, tetraphenylphosphonium phenoxide, trihexyltetradecylphosphonium decanoate and/or tetrabutylphosphonium fluoride.

It will be appreciated that mixtures of such catalysts can also be used. They are present in an amount of 0.001-5% by weight, preferably 0.01-3% by weight, based on components A) and, if present, B) in the polyurethane composition. The catalysts may contain water of crystallization, in which case such water is not taken into account when calculating the quantity of catalyst used; in other words, the amount of water is removed from the calculation.

One version of the invention includes the polymeric attachment of such catalysts C) to curing agents A) or hydroxyl-containing polymers B). For example, free alcohol, thio or amino groups of the catalysts can be reacted with acid, isocyanate or glycidyl groups of the curing agents A) or hydroxyl-containing polymers B), in order to integrate the catalysts C) into the polymeric system.

It should be borne in mind in this context that the activity of these catalysts is significantly decreased in the presence of acids. The conventional reaction partners of the uretdione-containing curing agents include hydroxyl-containing polyesters. Because of the way in which polyesters are prepared, they occasionally still include acid groups to a small extent. In the presence of polyesters which carry such acid groups it is appropriate either to use the catalysts mentioned in excess, relative to the acid groups, or else to add reactive compounds which are capable of scavenging acid groups.

Reactive acid-scavenging compounds D) are, for example, epoxy compounds, carbodiimides, hydroxyalkylamides or 2-oxazolines, but also inorganic salts such as hydroxides, hydrogen carbonates or carbonates. Suitable examples include triglycidyl ether isocyanurate (TGIC), EPIKOTE® 828 (diglycidyl ether based on bisphenol A, Shell), Versatic acid glycidyl esters, ethylhexyl glycidyl ether, butyl glycidyl ether, POLYPOX® R 16 (pentaerythritol tetraglycidyl ether, UPPC AG) and other Polypox grades containing free epoxy groups, VESTAGON® EP HA 320, (hydroxyalkylamide, Degussa AG), but also phenylenebisoxazoline, 2-methyl-2-oxazoline, 2-hydroxyethyl-2-oxazoline, 2-hydroxypropyl-2-oxazoline, 5-hydroxypentyl-2-oxazoline, sodium carbonate and calcium carbonate. It will be appreciated that mixtures of such substances are also suitable. These reactive compounds can be used in weight fractions of from 0.1 to 10%, preferably from 0.5 to 3%, based on the total formulation.

Acids specified under E) are all substances, solid or liquid, organic or inorganic, monomeric or polymeric, which possess the properties of a Brønsted acid or of a Lewis acid. Examples that may be mentioned include the following: sulfuric acid, acetic acid, benzoic acid, malonic acid, terephthalic acid, but also copolyesters or copolyamides having an acid number of at least 20. For powder coatings production it is possible to add the auxiliaries and additives F) customary in powder coatings technology, such as leveling agents, e.g., polysilicones or acrylates, light stabilizers, e.g., sterically hindered amines, or other auxiliaries, as described for example in EP 669 353, in a total amount of from 0.05 to 5% by weight. Fillers and pigments such as titanium dioxide, for example, can be added in an amount of up to 50% by weight of the total composition.

Optionally additional catalysts such as are already known in polyurethane chemistry may be present. These are primarily organometallic catalysts, such as dibutyltin dilaurate, or else tertiary amines, such as 1,4-diazabicyclo[2.2.2]octane, for example, in amounts of 0.001-1% by weight.

Conventional polyurethane compositions containing uretdione groups can under normal conditions (DBTL catalysis) be cured only at above 180° C. By means of the process of the invention it is possible to obtain low-temperature-curing polyurethane compositions which contain uretdione groups and which not only can be cured at not more than 160° C. (even lower curing temperatures are entirely possible) but additionally exhibit only slight, if any, surface defects.

In accordance with the invention the homogenization of all of the constituents for preparing a polyurethane composition is carried out in suitable mixing apparatus, such as heatable kneading apparatus, especially intensive kneaders, or intensive mixers, or static mixers, but preferably in extruders, in which upper temperature limits of 170° C. ought not to be exceeded. In principle it is the case that a brief thermal load, as low as possible, in interaction with the mixing action of the apparatus is sufficient to mix the constituents and the catalyst homogeneously without either reaction or decomposition taking place. “Brief” means that the residence time of the ingredients in the abovementioned apparatus is usually from 3 seconds to 15 minutes, preferably from 3 seconds to 5 minutes, more preferably from 5 to 180 seconds. Apparatus particularly suitable for the process of the invention and used with preference comprises extruders such as single-screw or multiple-screw extruders, especially twin-screw extruders, planetary roll extruders or annular extruders. It is essential to the invention, however, as mentioned above, that the incorporation of a highly active catalyst C) into a polyurethane composition containing uretdione groups take place in a mixing apparatus, the addition taking place
a) in a specific region, preferably after 10, 20, 30 to 90%, 40-80%, 55-75%, of the overall length of the mixing apparatus, preferably close to the exit die, more preferably approximately in the last third of the mixing apparatus,
b) in a specific temperature range, of from 70 to 170° C., of the melted polyurethane composition, preferably at very low temperatures of from 70 to 130° C.

Cooling downstream of mixing may be integrated in the same reaction section, in the form of a multibarrel embodiment as in the case of extruders or Contema machines. Additionally it is also possible to use tube bundles, tube coils, chill rolls, air conveyors and conveyor belts of metal.

In one preferred embodiment the process is carried out in an extruder.

The incorporation of the catalyst during extrusion can be varied as follows:

The polyurethane composition is metered as a solid into one of the first barrels of a corotating twin-screw extruder. The catalyst is fed as a solid or liquid into one of the barrels nearer the end.

The extruder possesses barrels which can be temperature-controlled (heated and cooled) separately. The barrel into which the polyurethane composition is metered is cooled (from 20 to 90° C. would be typical). The next barrel is temperature-controlled at slightly above the melting point of the mixture. All of the following barrels are maintained somewhat above this in temperature (40 to 150° C.). The exit temperature is slightly above the temperature of the last barrel (40 to 170° C.).

The catalyst is metered, depending on quantity, via a pipe or a nozzle into one of the barrels close to the extruder exit (corresponding to approximately 70% of the extruder length).

The extruder speed is from 100 to 400 rpm.

The emergent product is rapidly cooled (by way of a bed of chill rolls or a cooling belt, for example) and collected.

The construction of the screw is such as to enable the catalyst to be distributed rapidly and homogeneously. In the case of the screw elements it is possible to combine different elements depending on the aggregate state, quantity and thermolability of the catalyst (e.g., conveying elements differing in pitch and flight depth, kneading blocks, etc.).

It would be possible first to homogenize all of the constituents apart from the catalyst in an extruder and then to mix in the catalyst in a second extrusion step.

Another possibility is to mix in first the acid scavenger D) and thereafter the catalyst C) during extrusion, or else both the catalyst C) and the acid scavenger D) simultaneously.

Final processing is carried out in accordance with the viscosity of the product exiting the intensive kneader zone or post-reaction zone, initially by further cooling to an appropriate temperature by means of corresponding aforementioned devices. This is followed by pelletizing or else by comminution to a desired particle size, using roll crushers, pinned-disk mills, hammer mills, classifier mills, flaking rolls or the like.

Following cooling to room temperature and appropriate comminution, the extruded composition is ground to the ready-to-spray powder. The ready-to-spray powder can be applied to appropriate substrates in accordance with the known methods, such as by electrostatic powder spraying or fluidized-bed sintering, with or without electrostatic assistance, for example. Following powder application the coated workpieces are cured by heating at a temperature of from 120 to 220° C. for from 4 to 60 minutes, preferably at from 120 to 180° C. for from 6 to 30 minutes.

The subject matter of the invention is illustrated below with reference to examples.

Examples

| Ingredients | Product description, manufacturer |
|---|---|
| VESTAGON | Curing agent, Degussa AG, Coatings & Colorants, |
| BF 1320 | uretdione content: 13.8%, m.p.: 99-112° C., T_{g}: 87° C. |
| CRYLCOAT | OH polyester, OH number: 24.5; AN: 3.3; UCB |
| 240 | |
| ARALDIT | Triglycidyl ether isocyanurate (TGIC), Vantico |
| PT 810 | |
| KRONOS 2160 | Titanium dioxide, Kronos |
| RESIFLOW | Leveling agent, Worlee |
| PV 88 | |
| TBAH | Tetrabutylammonium hydroxide, WC: 68, Aldrich |

OH number: consumption of mg KOH/g of polymer; AN: acid number, consumption in mg KOH/g of polymer
m.p.: melting point; T_{g}: glass transition point; WC: water content in % by weight
General Preparation Instructions for the Polyurethane Composition:

The comminuted ingredients—curing agent, hydroxy-functional polymers, acid scavenger, leveling agent—are intimately mixed in an edge runner mill and then homogenized in an extruder.

The finished mixture in powder form is fed continuously via a solids metering balance into a corotating twin-screw extruder.

The throughput is 2.0 kg/h (DSK 25).

The extruder possesses barrels which can be temperature-controlled (heated and cooled) separately.

Barrel 1 is controlled to room temperature, barrel 2 is heated at 95 to 115° C., the following barrels are controlled at 120 to 130° C. The catalyst in liquid form is metered at room temperature into a barrel after 70% of the extruder length.

The exit temperature of the product is from 121 to 135° C.

The extruder speed is approximately 200 rpm.

The white melt which emerges is cooled on a bed of chill rolls and subsequently collected.

Preparation of a Powder Coating Material:

The extrudate is cooled, fractionated and ground with a pinned-disk mill to a particle size <100 μm. The powder produced in this way is applied to degreased iron panels using an electrostatic powder spraying unit at 60 kV and baked in a forced-air drying oven.

Powder Coating Compositions (Amounts in % by Weight, Apart from for OH/UD):

| Exam- | VESTAGON | Crylcoat | | Addition of | |
|---|---|---|---|---|---|
| ples | BF 1320 | 240 | TBAH | catalyst TBAH | OH/UD |
| 1 | 11.27 | 45.23 | 1.00 | after 70% of | 1.00:0.75 |
| | | | | the extruder | |
| | | | | length | |
| C1* | 11.27 | 45.23 | 1.00 | at the begin- | 1.00:0.75 |
| | | | | ning (0%) of | |
| | | | | the extruder | |
| | | | | length | |

*noninventive comparative examples

OH/UD: ratio of OH groups to uretdione groups (mol:mol)

Additionally used in each of the formulations were 40.0% by weight of KRONOS 2160, 1.0% by weight of RESIFLOW PV 88 and 1.5% by weight of Araldit PT 810.

Results of Curing after 30 Minutes at 160° C.:

| | Erichsen | Gloss 60° | |
|---|---|---|---|
| | cupping | [scale | |
| Examples | [mm] | divisions] | Remarks |
| 1 | >10.0 | 74 | cured, good leveling |
| C1* | 9.0 | 2 | cured, rough surface |

The process of the invention leads to glossy powder coatings without surface defects, while the noninventive process is accompanied by distinct defects in the powder coating surface.

Erichsen cupping in accordance with DIN 53 156

Determination of degree of gloss in accordance with ISO 2813

1. A process for preparing a solid highly reactive polyurethane composition containing uretdione groups by mixing
A) at least one uretdione-containing curing agent which has a free NCO content of less than 5% by weight and a uretdione content of 1-30% by weight, based on aromatic, aliphatic, (cyclo)aliphatic or cycloaliphatic polyisocyanates and hydroxyl-containing compounds, with a melting point of from 40 to 130° C.,
and
B) if desired at least one hydroxyl-containing polymer having a melting point of from 40 to 130° C. and an OH number of between 20 and 200 mg KOH/gram,
C) in the presence of at least one catalyst
C1) of the formula M(OR¹)ₙ(OR²)ₘ(OR³)ₒ(OR⁴)ₚ(OR⁵)_{q}(OR⁶)ᵣ, where M is a metal in any positive oxidation state and identical to the sum n+m+o+p+q+r, m, o, p, q and r are integers from 0 to 6 and the sum n+m+o+p+q+r=1-6, the radicals R¹-R⁶ simultaneously or independently of one another are hydrogen or alkyl, aryl, aralkyl, heteroaryl or alkoxyalkyl radicals having 1-8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, urethane, urea or allophanate groups, double bonds, triple bonds or halogen atoms,
and/or
C2) comprising tetraalkylammonium salts of the formula [NR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F,
and/or
C3) of the formula [NR¹R²R³R⁴]⁺[R⁵COO]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical, linear or branched, having 1-18 carbon atoms and may further contain one or more alcohol, amino, ester, keto, thio, acid, urethane, urea or allophanate groups, double bonds, triple bonds or halogen atoms,
and/or
C4) comprising metal acetylacetonates of the formula Mⁿ⁺(acac⁻)ₙ, where M=metal ion, n is a natural number, with n=1-6, and acac is bis(2,4-pentanedionato),
C5) comprising phosphonium compounds of the formula [PR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F or is R⁶COO where R⁶ is synonymous with alkyl, aryl, aralkyl, heteroaryl or alkoxyalkyl radicals, linear or branched, having 1-18 carbon atoms and may further contain one or more alcohol, amino, ester, keto, thio, acid, urethane, urea or allophanate groups, double bonds, triple bonds or halogen atoms,
so that the fraction of the catalyst under C) is 0.001-5% by weight of the total amount of components A) and, if present, B),
D) if desired, a reactive compound which is able to react at elevated temperatures with the acid groups of component B) that may be present and whose fraction is from 0.1 to 10% by weight based on the total amount of A) and, if present, B),
E) if desired, at least one acid in monomeric or polymeric form, in a weight fraction, based on the total formulation, of from 0.1 to 10%,
F) if desired, auxiliaries and additives
in a mixing apparatus selected from an extruder, intensive kneader, intensive mixer or static mixer, component C) being added subsequently in the mixing apparatus to components A) and, if present, B), D), E) and/or F) already partly or fully mixed in the mixing apparatus and being mixed with the other components and subsequently isolating the end product by cooling.

2. The process as claimed in claim 1, wherein component C) is added to the mixture after from 10 to 90% of the overall length of the mixing apparatus.

3. The process as claimed in claim 1, wherein component C) is added to the mixture after from 20 to 90% of the overall length of the mixing apparatus.

4. The process as claimed in claim 1, wherein component C) is added to the mixture after from 30 to 90% of the overall length of the mixing apparatus.

5. The process as claimed in claim 1, wherein component C) is added to the mixture after from 40 to 80% of the overall length of the mixing apparatus.

6. The process as claimed in claim 1, wherein component C) is added to the mixture after from 55 to 75% of the overall length of the mixing apparatus.

7. The process as claimed in claim 1, wherein the temperature on addition of component C) is from 70 to 170° C.

8. The process as claimed in claim 1, wherein component A) is based on the polyisocyanates selected from isophorone diisocyanate (IPDI), hexamethylene diisocyanate (HDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), methylenediphenyl diisocyanate (MDI) and tetramethylxylylene diisocyanate (TMXDI).

9. The process as claimed in claim 1, wherein polyesters, polythioethers, polyethers, polycaprolactams, polyepoxides, polyesteramides, polyurethanes and/or, if desired, low molecular mass di-, tri- and/or tetraalcohols as chain extenders and/or, if desired, monoamines and/or monoalcohols as chain terminators are present as hydroxyl-containing compounds of component A).

10. The process as claimed in claim 1, wherein polyesters, polyethers, polyacrylates, polyurethanes and/or polycarbonates having an OH number of from 20 to 200 mg KOH/gram are present as component B).

11. The process as claimed in claim 1, wherein compounds selected from lithium hydroxide, sodium hydroxide, potassium hydroxide, rubidium hydroxide, cesium hydroxide, beryllium hydroxide, magnesium hydroxide, calcium hydroxide, strontium hydroxide, barium hydroxide, aluminum hydroxide, zinc hydroxide, lithium methoxide, sodium methoxide, potassium methoxide, magnesium methoxide, calcium methoxide, barium methoxide, lithium ethoxide, sodium ethoxide, potassium ethoxide, magnesium ethoxide, calcium ethoxide, barium ethoxide, lithium propoxide, sodium propoxide, potassium propoxide, magnesium propoxide, calcium propoxide, barium propoxide, lithium isopropoxide, sodium isopropoxide, potassium isopropoxide, magnesium isopropoxide, calcium isopropoxide, barium isopropoxide, lithium 1-butoxide, sodium 1-butoxide, potassium 1-butoxide, magnesium 1-butoxide, calcium 1-butoxide, barium 1-butoxide, lithium 2-butoxide, sodium 2-butoxide, potassium 2-butoxide, magnesium 2-butoxide, calcium 2-butoxide, barium 2-butoxide, lithium isobutoxide, sodium isobutoxide, potassium isobutoxide, magnesium isobutoxide, calcium isobutoxide, barium isobutoxide, lithium tert-butoxide, sodium tert-butoxide, potassium tert-butoxide, magnesium tert-butoxide, calcium tert-butoxide, barium tert-butoxide, lithium phenoxide, sodium phenoxide, potassium phenoxide, magnesium phenoxide, calcium phenoxide and/or barium phenoxide are present as catalysts C1).

12. The process as claimed in claim 1, wherein compounds selected from methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride and/or benzyltrimethylammonium fluoride are present as catalysts C2).

13. The process as claimed in claim 1, wherein compounds selected from tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and/or tetrabutylammonium benzoate are present as catalysts C3).

14. The process as claimed in claim 1, wherein compounds selected from zinc acetylacetonate and/or lithium acetylacetonate are present as catalysts C4).

15. The process as claimed in claim 1, wherein compounds selected from tetrabutylphosphonium acetate, tetrabutylphosphonium benzotriazolate, tetrabutylphosphonium hydroxide, ethyltriphenylphosphonium acetate, tetraphenylphosphonium phenoxide, trihexyltetradecylphosphonium decanoate and/or tetrabutylphosphonium fluoride are present as catalysts C5).

16. The process as claimed in claim 1, wherein compounds selected from triglycidyl ether isocyanurate (TGIC), EPIKOTE 828 (diglycidyl ether based on bisphenol A, Shell), Versatic acid glycidyl esters, ethylhexyl glycidyl ether, butyl glycidyl ether, POLYPOX R 16 (pentaerythritol tetraglycidyl ether, UPPC AG) and other Polypox grades containing free epoxy groups, VESTAGON EP HA 320, (hydroxyalkylamide, Degussa AG), or phenylenebisoxazoline, 2-methyl-2-oxazoline, 2-hydroxyethyl-2-oxazoline, 2-hydroxypropyl-2-oxazoline, 5-hydroxypentyl-2-oxazoline, sodium carbonate and/or calcium carbonate are present as component D).

17. The process as claimed in claim 1, wherein compounds selected from sulfuric acid, acetic acid, benzoic acid, malonic acid, terephthalic acid, copolyesters and/or copolyamides having an acid number of at least 20 are present as component E).

18. The process as claimed in claim 1, wherein additional catalysts, leveling agents, light stabilizers, fillers and/or pigments are present as component F).

19. The process as claimed in claim 1, wherein an extruder is used as apparatus.

20. The process as claimed in claim 19, wherein single-screw or multiple-screw extruders, especially twin screw extruders, planetary roll extruders or annular extruders are used.

21. The process as claimed in claim 1, wherein the residence time of the ingredients in the above-mentioned apparatus is from 3 seconds to 15 minutes.

22. The process as claimed in claim 1, wherein mixing takes place at a temperature below 170° C.

23. A solid highly reactive polyurethane composition containing uretdione groups and obtained by mixing
A) at least one uretdione-containing curing agent which has a free NCO content of less than 5% by weight and a uretdione content of 1-30% by weight, based on aromatic, aliphatic, (cyclo)aliphatic or cycloaliphatic polyisocyanates and hydroxyl-containing compounds, with a melting point of from 40 to 130° C.,
and
B) if desired at least one hydroxyl-containing polymer having a melting point of from 40 to 130° C. and an OH number of between 20 and 200 mg KOH/gram,
C) in the presence of at least one catalyst
C1) of the formula M(OR¹)ₙ(OR²)ₘ(OR³)ₒ(OR⁴)ₚ(OR⁵)_{q}(OR⁶)ᵣ, where M is a metal in any positive oxidation state and identical to the sum n+m+o+p+q+r, m, o, p, q and r are integers from 0 to 6 and the sum n+m+o+p+q+r=1-6, the radicals R¹-R⁶ simultaneously or independently of one another are hydrogen or alkyl, aryl, aralkyl, heteroaryl or alkoxyalkyl radicals having 1-8 carbon atoms and the radicals may in each case be linear or branched, unbridged or bridged with other radicals, to form monocyclic, bicyclic or tricyclic systems, and the bridging atoms may in addition to carbon also be heteroatoms and additionally may have one or more alcohol, amino, ester, keto, thio, urethane, urea or allophanate groups, double bonds, triple bonds or halogen atoms,
and/or
C2) comprising tetraalkylammonium salts of the formula [NR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F,
and/or
C3) of the formula [NR¹R²R³R⁴]⁺[R⁵COO]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is an alkyl, aryl, aralkyl, heteroaryl or alkoxyalkyl radical, linear or branched, having 1-18 carbon atoms and may further contain one or more alcohol, amino, ester, keto, thio, acid, urethane, urea or allophanate groups, double bonds, triple bonds or halogen atoms,
and/or
C4) comprising metal acetylacetonates of the formula Mⁿ⁺(acac⁻)ₙ, where M=metal ion, n is a natural number, with n=1-6, and acac is bis(2,4-pentanedionato),
C5) comprising phosphonium compounds of the formula [PR¹R²R³R⁴]⁺[R⁵]⁻, where R¹-R⁴ simultaneously or independently of one another are alkyl, aryl, aralkyl, heteroaryl or alkoxyalkyl radicals having 1-18 carbon atoms and being in each case linear or branched, unbridged or bridged with other radicals R¹-R⁴, to form monocyclic, bicyclic or tricyclic systems, and the bridging atoms may in addition to carbon also be heteroatoms, and each radical R¹-R⁴ may further contain one or more alcohol, amino, ester, keto, thio, urethane, urea or allophanate groups, double bonds, triple bonds or halogen atoms, and R⁵ is either OH or F or is R⁶COO where R⁶ is synonymous with alkyl, aryl, aralkyl, heteroaryl or alkoxyalkyl radicals, linear or branched, having 1-18 carbon atoms and may further contain one or more alcohol, amino, ester, keto, thio, acid, urethane, urea or allophanate groups, double bonds, triple bonds or halogen atoms,
so that the fraction of the catalyst under C) is 0.001-5% by weight of the total amount of components A) and, if present, B),
D) if desired, a reactive compound which is able to react at elevated temperatures with the acid groups of component B) that may be present and whose fraction is from 0.1 to 10% by weight based on the total amount of A) and, if present, B),
E) if desired, at least one acid in monomeric or polymeric form, in a weight fraction, based on the total formulation, of from 0.1 to 10%,
F) if desired, auxiliaries and additives
in a mixing apparatus selected from an extruder, intensive kneader, intensive mixer or static mixer, component C) being added subsequently in the mixing apparatus to components A) and, if present, B), D), E) and/or F) already partly or fully mixed in the mixing apparatus and being mixed with the other components and subsequently isolating the end product by cooling.

24. The solid highly reactive polyurethane composition containing uretdione groups as claimed in claim 23, comprising compounds A) to F) as set forth in claim 2.

25. The use of a solid polyurethane composition containing uretdione groups and prepared as set forth in claim 1, curing at a low baking temperature, for producing a powder coating material.
